(19) United States
(12) Patent Application Publication
(10) Pub. No.: US 2020/0118742 A1
(43) Pub. Date: Apr. 16, 2020

(54) ALIGNMENT OF MAGNETIC MATERIALS DURING POWDER DEPOSITION OR SPREADING IN ADDITIVE MANUFACTURING

(71) Applicant: UNIVERSITY OF PITTSBURGH - OF THE COMMONWEALTH SYSTEM OF HIGHER EDUCATION, Pittsburgh, PA (US)

(72) Inventors: Markus Chmielus, Pittsburgh, PA (US); Yuval Krimer, Pittsburgh, PA (US); Amir Mostafaei, Pittsburgh, PA (US); Erica Stevens, Pittsburgh, PA (US); Jakub Toman, Pittsburgh, PA (US)

(73) Assignee: UNIVERSITY OF PITTSBURGH - OF THE COMMONWEALTH SYSTEM OF HIGHER EDUCATION, Pittsburgh, PA (US)

(21) Appl. No.: 16/616,246

(22) PCT Filed: May 25, 2018
(86) PCT No.: PCT/US2018/034731

§ 371 Date: Nov. 22, 2019

Related U.S. Application Data
(60) Provisional application No. 62/511,164, filed on May 25, 2017.

(51) Int. Cl. H01F 41/32; H01F 10/08; H01F 1/08; H01F 1/22; H01F 41/02

(52) U.S. Cl. CPC H01F 41/32; H01F 10/08; H01F 41/0273; H01F 1/22; H01F 1/086

(57) ABSTRACT

A method for producing an MSMA, a magnetic material or a magnetic item via additive manufacturing, comprising: (a) providing or forming a layer of magnetic/ferromagnetic particles; (b) applying a magnetic field, having a first three-dimensional (“3D”) magnetic field vector with respect to an origin point of a 3D coordinate system, to the layer of particles or portion thereof, either while pressure is or is not applied to hold the particles in place, to align the magnetic moments of the magnetic particles in the layer or portion thereof during or after the providing or forming of the layer or portion thereof; (c) applying means for binding the layer wherein means for binding may comprise a binder material or complete/partial sintering of the layer; (d) providing or forming a next layer of magnetic/ferromagnetic particulate material on to the previous layer; (e) applying a magnetic field, having a next 3D magnetic field vector with respect to the origin point of the 3D coordinate system, to the next layer of particles or portion thereof, either while pressure is or is not applied to hold the particles in place, to align the magnetic moments of the magnetic particles in the next layer or portion thereof during or after the providing or forming of the next layer or portion thereof; and (f) applying means for binding the next layer wherein means for binding may comprise a binder material or complete/partial sintering of next layer.

### CROSS REFERENCE TO RELATED APPLICATIONS

This application claims the benefit of provisional patent application U.S. Ser. No. 62/511,164 filed May 25, 2017, which is incorporated by reference herein for all purposes.

### BACKGROUND OF THE DISCLOSURE

During spreading or deposition of magnetic powder particles during additive manufacturing (AM), powder particles get randomly oriented (see FIG. 1). For certain magnetic materials, a random orientation in bulk parts is not desirable. The magnetic properties of the powder particles might cancel or weaken each other in the bulk part which consists of more than one powder particle and, thus, this weakening or cancellation results in no significant overall magnetic moment of the part built from magnetic particles (see FIG. 1). By orienting or aligning the magnetic powder particles during the build of the part, the magnetic properties of the bulk part will be multiples of the properties of the individual powder particle. This is desirable in functional magnetic materials, including but not limited to magnetic/ferromagnetic shape memory alloys (MSMA), magnetocaloric materials (MCM), peimanent magnetics (PM).

Currently, there is no technique, especially in powder bed binder jet printing, that would allow for the microstructural or magnetic moment alignment of powder particles within a bulk metal part. On the other hand, there is a paper describing “Multimaterial magnetically assisted 3D printing of composite materials” Nature Communications 6, Article 8643, doi:10.1038/nc0mms9643, Dimitri Kokkinis, Manuel Schaffner & Andre R. Studart, that describes orientation control in inkjet printing by embedding anisotropic magnetic particles in ink. This is different from the present disclosure, since according to the present disclosure, the particles are first aligned and then the binder is added to lock in the orientation of the powder particles. Also, fully dense metal parts are created via the present disclosure, especially functional magnetic metal parts and not polymer parts with embedded particles.

There is another technique currently offered that is not really similar to the present disclosure from the company Polymagnet (http://www.polymagnet.com/polyrnagnets/). This company has many patents related to their technology. But their approach is very different since they need a pad (sheet) of magnetic material and then change the magnetization direction locally. They do not use AM to produce magnetized parts.

Furthermore, there is a development described in “3D print of polymer bonded rare-earth magnets, and 3D magnetic field scanning with an end-user 3D printer” C. Huber et al., Applied Physics Letters DOI: 10.1063/1.4964856 and also highlighted in a press release (http://www.tuwien.ac.at/en/news/news %20detail/article/12442%20detail/article/124429) that produces permanent magnets via an extrusion 3D printing method. The resulting magnetic material is embedded in a polymer matrix, and so is equivalent to a bonded magnet. This development acknowledges that the result is not a sintered magnet. Thus the technology described within the present disclosure is differentiated from the development published by Huber et al. in that it creates magnetic material in a complex shape in preparation for sintering, and so seeks to displace or augment sintered magnet technology (as opposed to bonded magnet technology).

Finally, another development that was published at nearly the same time as the one by Huber et al. is described in “Big Area Additive Manufacturing of High Performance Bonded NdFeB Magnets” Ling Li et al., Scientific Reports D01:10.1038/5rep36212 and also highlighted in a press release (haps://wvvw.sciencedaily.com/releases/2016/11/161101135328.htm). This development also involves using a 3D printing (additive manufacturing) method to produce magnetic material embedded in a polymer matrix, and so also is likely to displace bonded magnet technology. Again, the technology described in the present disclosure seeks to displace or augment sintered magnet technology, which by virtue of a higher density of magnetic material creates magnets with higher magnetic field strengths than bonded magnet technology (all else being equal).

So far in AM, magnetic moments of magnetic powder particles are not aligned, but the preferred methods of the present disclosure provide for designed alignment of magnetic moments of magnetic powder particles in one direction over the entire bulk part or even purposefully designed changing orientation of magnetic moments throughout a bulk material made of magnetic powder particles.

### BRIEF SUMMARY OF THE DISCLOSURE

Many other variations are possible with the present disclosure, and those and other teachings, variations, and advantages of the present disclosure will become apparent from the description and figures of the disclosure.

One aspect of a preferred embodiment of the present disclosure comprises a method for producing an MSMA, a magnetic material or a magnetic item via additive manufacturing, comprising: (a) providing or forming a layer of magnetic/ferromagnetic particles; (b) applying a magnetic field, having a first three-dimensional (“3D”) magnetic field vector with respect to an origin point of a 3D coordinate system, to the layer of particles or portion thereof, either while pressure is or is not applied to hold the particles in place, to align the magnetic moments of the magnetic particles in the layer or portion thereof during or after the providing or forming of the layer or portion thereof; (c) applying means for binding the layer wherein means for binding may comprise a binder material or complete/partial sintering of the layer; (d) providing or forming a next layer of magnetic/ferromagnetic particulate material on to the previous layer; (e) applying a magnetic field, having a next 3D magnetic field vector with respect to the origin point of the 3D coordinate system, to the next layer of particles or portion thereof, either while pressure is or is not applied to hold the particles in place, to align the magnetic moments of the magnetic particles in the next layer or portion thereof during or after the providing or forming of the next layer or portion thereof; and (f) applying means for binding the next layer wherein means for binding may comprise a binder material or complete/partial sintering of next layer.

In another aspect of a preferred method for producing an MSMA, a magnetic material or a magnetic item via additive manufacturing of the present disclosure, the first 3D magnetic field vector is equal to or not equal to the next 3D magnetic field vector.

In yet another aspect, a preferred method for producing an MSMA, a magnetic material or a magnetic item via additive manufacturing of the present disclosure further comprises repeating steps (d)-(f) until an interim shape of the item is complete.

In another aspect of a preferred method for producing an MSMA, a magnetic material or a magnetic item via additive manufacturing of the present disclosure, the first 3D magnetic field vector is equal to or not equal to each of the next 3D magnetic field vectors.

In a further aspect of a preferred method for producing an MSMA, a magnetic material or a magnetic item via additive manufacturing of the present disclosure, each of the first and next 3D magnetic field vectors is different from each other.

In another aspect of a preferred method for producing an MSMA, a magnetic material or a magnetic item via additive manufacturing of the present disclosure, the 3D magnetic field vectors applied to alternating layers of the item are equal.

In yet another aspect, a preferred method for producing an MSMA, a magnetic material or a magnetic item via additive manufacturing of the present disclosure further comprises curing the binder material where a binder material has been used as the means for binding to create an interim shape of the MSMA, the magnetic material or the magnetic item.

In a further aspect, a preferred method for producing an MSMA, a magnetic material or a magnetic item via additive manufacturing of the present disclosure further comprises sintering the interim shape to remove the binder material to produce a final shape of the MSMA, the magnetic material or the magnetic item having increased density and stability.

In another aspect of a preferred method for producing an MSMA, a magnetic material or a magnetic item via additive manufacturing of the present disclosure, the magnetic moments of the particles in each layer have 3D magnetic field vectors that are (i) substantially the same, (ii) parallel, (iii) antiparallel or (iv) different from layer to layer.

In yet another aspect of a preferred method for producing an MSMA, a magnetic material or a magnetic item via additive manufacturing of the present disclosure, the magnetic moments of the particles in alternating layers have 3D magnetic field vectors that are (i) substantially the same, (ii) parallel or (iii) antiparallel.

In a further aspect of a preferred method for producing an MSMA, a magnetic material or a magnetic item via additive manufacturing of the present disclosure, the 3D magnetic field vectors of the magnetic moments of the particles gradually change over a plurality of layers from a first direction relative to one axis of the 3D coordinate system to a second direction relative to said axis.

In another aspect of a preferred method for producing an MSMA, a magnetic material or a magnetic item via additive manufacturing of the present disclosure, the first direction is perpendicular to the second direction.

In an additional aspect of a preferred method for producing an MSMA, a magnetic material or a magnetic item via additive manufacturing of the present disclosure, the net magnetic moments of (i) each layer have 3D magnetic field vectors that are substantially the same, parallel, antiparallel or different from layer to layer; (ii) alternating layers have 3D magnetic field vectors that are substantially the same, parallel or antiparallel; or (iii) each layer have 3D magnetic field vectors that gradually change over a plurality of layers from a first direction relative to one axis of the 3D coordinate system to a second direction relative to said axis, wherein the first direction is or is not perpendicular to the second direction.

Another aspect of a preferred embodiment of the present disclosure comprises a magnetic material or item without polymer matrix, comprising: a plurality of layers wherein each layer comprises magnetic particles and wherein the magnetic moments of the particles in each layer have 3D magnetic field vectors that (i) are substantially the same, (ii) are parallel, (iii) are antiparallel, (iv) are different from layer to layer or (v) gradually change over a plurality of layers from a first direction relative to one axis of a 3D coordinate system to a second direction relative to said axis, wherein the first direction is or is not perpendicular to the second direction.

Yet another aspect of a preferred embodiment of the present disclosure comprises a magnetic material or item without polymer matrix, comprising: a plurality of layers wherein each layer comprises magnetic particles and wherein a net magnetic moment of each layer has 3D magnetic field vector that (i) is substantially the same as, parallel to, antiparallel to or different from, the 3D magnetic field vector of each of the other plurality of layers; (ii) gradually changes over the plurality of layers from a first direction relative to one axis of a 3D coordinate system to a second direction relative to said axis, wherein the first direction is or is not perpendicular to the second direction.

### BRIEF DESCRIPTION OF THE SEVERAL VIEWS OF THE DRAWINGS

For the present disclosure to be easily understood and readily practiced, the present disclosure will now be described for purposes of illustration and not limitation in connection with the following figures, wherein:

FIG. 1(A) shows a symbol key for FIGS. 1(B) and 1(C);

FIG. 1(B) shows normal powder distribution of non-magnetic powder particles in a build box of a typical additive manufacturing process;

FIG. 1(C) shows normal powder distribution of magnetic powder particles in a build box of a typical additive manufacturing process;

FIG. 2(A) shows a symbol key for FIGS. 2(B)-2(G);

FIG. 2(B) shows Example 1: vertically aligned magnetic powder particles due to vertically applied magnetic field in a build box in a preferred additive manufacturing process according to the present disclosure;

FIG. 2(C) shows Example 2: vertically aligned magnetic powder particles due to vertically applied magnetic field in a build box in a preferred additive manufacturing process according to the present disclosure;

FIG. 2(D) shows Example 3: horizontally aligned magnetic powder particles due to horizontally applied magnetic field in a build box in a preferred additive manufacturing process according to the present disclosure;

FIG. 2(E) shows Example 4: horizontally aligned magnetic powder particles due to horizontally applied magnetic field in a build box in a preferred additive manufacturing process according to the present disclosure;

FIG. 2(F) shows Example 5: alternating magnetization direction in neighboring layers in a build box in a preferred additive manufacturing process according to the present disclosure wherein the large arrows on the right indicate net magnetization within each corresponding layer;

FIG. 2(G) shows Example 6: gradually changing magnetization direction through neighboring layers in a build box in a preferred additive manufacturing process according to the present disclosure wherein the large arrows on the right indicate net magnetization within each corresponding layer;

FIG. 3(A) shows a symbol key for FIGS. 3(B)-3(F) showing Steps 1-5 a preferred additive manufacturing process according to the present disclosure;

FIG. 3(B) shows Step 1: providing a layer of vertically aligned magnetic powder particles due to vertically applied magnetic field in a build box in the preferred additive manufacturing process of FIG. 3;

FIG. 3(C) shows Step 2: applying binder, lowering build box for next layer of vertically aligned magnetic powder particles due to vertically applied magnetic field in the preferred additive manufacturing process of FIG. 3;

FIG. 3(D) shows Step 3: repeating Steps 1 and 2 until build is finished in the preferred additive manufacturing process of FIG. 3;

FIG. 3(E) shows Step 4: curing the binder and removing the build from the build box in the preferred additive manufacturing process of FIG. 3;

FIG. 3(F) shows optional Step 5: sintering the build to remove the binder and to increase the density and stability of the build in the preferred additive manufacturing process of FIG. 3;

FIG. 4 shows Steps 1-5 a preferred additive manufacturing process according to the present disclosure;

FIG. 4(A) shows Step 1: providing a layer of magnetic powder particles in a build box in the preferred additive manufacturing process of FIG. 4;

FIG. 4(B) shows Step 2: using a plate to apply pressure to the layer of magnetic powder particles in the build box in the preferred additive manufacturing process of FIG. 4;

FIG. 4(C) shows Step 3: plate continues to apply pressure to the layer of magnetic powder particles while a magnetic field is applied thereto in the build box in the preferred additive manufacturing process of FIG. 4;

FIG. 4(D) shows Step 4: plate continues to apply pressure to the layer of magnetic powder particles while the magnetic field is removed in the preferred additive manufacturing process of FIG. 4;

FIG. 4(E) shows Step 5: plate is removed and the layer is ready for application of binder or other joining process with the layer of magnetic powder particles having a net magnetization in generally the same direction as the previously applied magnetic field according to the preferred additive manufacturing process of FIG. 4;

FIG. 5 presents magnetic anisotropy data for a magnetic item that was weakly magnetized during powder bed binder jet printing according to a preferred method of the present disclosure shown in FIG. 3;

FIG. 6(A) shows an exemplary sintered Ni—Mn—Ga MSMA made according to a preferred method of the present disclosure;

FIG. 6(B) is a graph showing no composition gradient is present in the sintered Ni—Mn—Ga MSMA structure of FIG. 6(A) made according to a preferred method of the present disclosure;

FIG. 7(A) shows micro computed tomography (3D slice) of a slightly sintered item made according to a preferred method of the present disclosure; and

FIG. 7(B) shows micro computed tomography (2D slices) of a slightly sintered made according to a preferred method of the present disclosure.

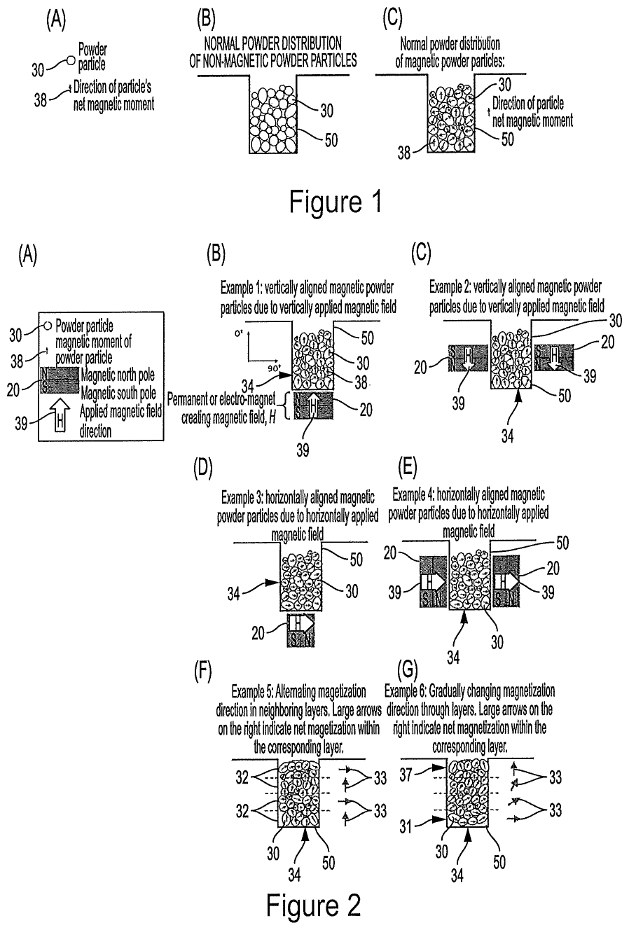

### DETAILED DESCRIPTION

In the following detailed description, reference is made to the accompanying examples and figures that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “disclosure” merely for convenience and without intending to voluntarily limit the scope of this application to any single disclosure or inventive concept if more than one is in fact disclosed.

The following description is, therefore, not to be taken in a limited sense, and the scope of this disclosure is defined by the appended claims.

Herein, the term “magnetic” material/powder particle includes all kinds of materials that exhibit ferromagnetic properties at any and all temperature(s).

### Benefit Examples

In AM of magnetic shape memory alloys or other functional magnetic materials: without alignment, these functional materials show, if at all, very little and limited functionality. Only closely aligned grains will be able to either deform within an applied changing magnetic field, or change their magnetic orientation due to an applied stress or show other desired functionality.

In AM of permanent magnetics: without alignment, permanent magnetic will not exhibit full magnetic strength. Magnetic moments of individual powder particles 30 will cancel each other out. Thus, producing permanent magnets is not possible with current AM processes. Aligning particles during AM in a way that their magnetic moments are approximately aligned results in a permanent magnet with a significant magnetic field 33.

In AM of magnetic materials in general: if microstructural alignment is desired due to better overall properties—including but not limited to mechanical, thermal, electrical, optical, and magnetic properties—an alignment of microstructure during AM is very beneficial.

For magnetic parts, changing magnetic orientation will be useful to optimize magnetic properties with regards to the desired application, including but not limited to optimized magnetic flux, density, field and orientation. Example 5 of FIG. 2(F) demonstrates a preferred build 34 according to the present disclosure that contains alternating vertical and horizontal net magnetization directions 33 between neighboring layers 32. Example 6 of FIG. 2(G) demonstrates a preferred build 34 according to the present disclosure within which the net magnetization direction 33 gradually changes from bottom layer 31 to top layer 37.

Application Examples of the Methods Present Disclosure:

AM of functional MSMA, MCM.

AM of permanent magnetic, including but not limited to permanent magnets with complex shapes and varying orientation.

Designed microstructural orientation alignment of magnetic materials in general by means of AM.

AM of oriented magnetic steels, including but not limited to complex shapes and varying orientation (for example those used in motor laminations).

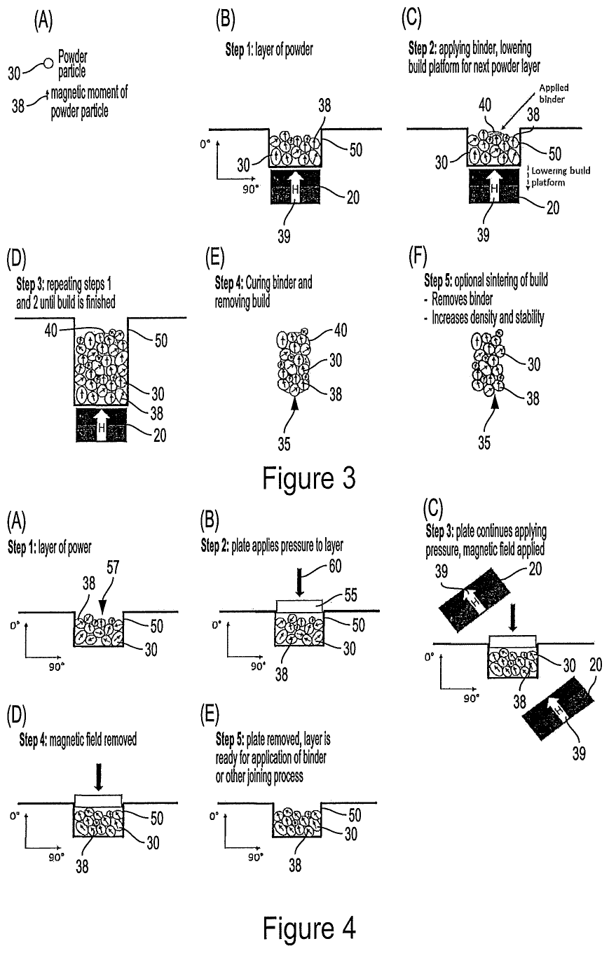

Process of the Present Disclosure (FIGS. 2 and 3 on the Example of Powder Bed Binder Jet Printing):

(1) Magnets 20 (permanent or electromagnetic) are placed either underneath and/or on the sides of the deposit of magnetic powder particles 30 in direct powder deposition AM methods or build box 50 in preferred powder bed AM methods of the present disclosure (FIG. 2 shows an example of a powder bed AM method). As shown in FIGS. 2-4, in preferred methods of the present disclosure, magnets or electromagnets 20 are used to apply the magnetic field to the layers. Further, magnets or electromagnets 20 preferably may be applied underneath or to one or both sides of the build box 50 or layer(s) 32 to apply the magnetic field 39 to the layer(s) 32 or build 34.

(2) Magnetic powder particles 30 are deposited directly via nozzles or positioned layer by layer. Materials with easy directions of magnetization will align the easy direction of magnetization parallel to the magnetic field lines of the external magnets 20 (step 1 in FIG. 3(B)).

(3) (a) Powder bed AM methods that do not melt powder before deposition and during printing: magnetic powder particles align with the applied magnetic field during deposition. These powders will be stabilized by binder 40 (that will be subsequently cured and the powder sintered), see FIG. 3 steps 2-5. During sintering, even liquid sintering, crystal structure alignment will not be lost due to crystalline cores that are the seeds for the solidifying volume during cool down.

(b) Powder bed AM methods that partially melt/sinter powder particles during printing using laser or electron beam processing. When partially melted, remaining solid and aligned powder cores will be the solidification seeds/nucleation sites and solidified structures will still be aligned.

(c) Methods that melt the powder during deposition of the layer: powder will solidify and direction of crystal unit cell direction will be influenced and aligned by the magnets and/or electromagnets during solidification.

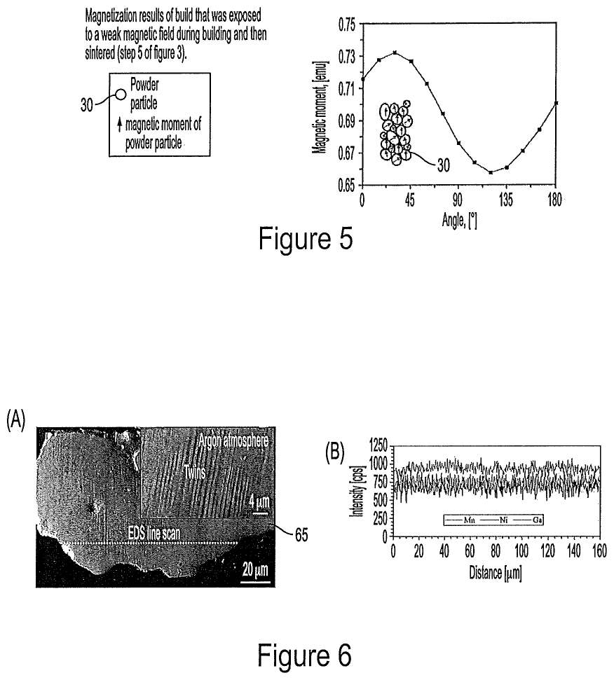

(4) Final structures/parts (e.g., 35 of FIG. 3(F)) will have crystal lattices oriented according to the applied magnetic field during the additive manufacturing powder deposition process and show a preferred magnetic direction as shown in FIG. 5, which presents magnetic anisotropy data for a sample item 35 that was weakly magnetized during powder bed binder jet printing according to a preferred AM method of the present disclosure as shown in FIG. 3.

Example 1 of FIG. 2(B) shows build 34 having vertically aligned magnetic moments 38 of magnetic powder particles 30 due to vertically applied magnetic field 39 by magnets 20 according to a preferred method of the present disclosure.

Example 2 of FIG. 2(C) shows build 34 having vertically aligned magnetic moments 38 of magnetic powder particles 30 due to vertically applied magnetic field 39 by magnets 20 according to another preferred method of the present disclosure.

Example 3 of FIG. 2(D) shows build 34 having horizontally aligned magnetic moments 38 of magnetic powder particles 30 due to horizontally applied magnetic field 39 by magnets 20 according to a preferred method of the present disclosure.

Example 4 of FIG. 2(E) shows build 34 having horizontally aligned magnetic moments 38 of magnetic powder particles 30 due to horizontally applied magnetic field 39 by magnets 20 according to another preferred method of the present disclosure.

Example 5 of FIG. 2(F) demonstrates a build or sample 34 that contains alternating vertical and horizontal net magnetization directions 33 between neighboring layers 32. Example 6 of FIG. 2(G) demonstrates a build 34 within which the net magnetization direction 33 gradually changes from bottom layer 31 to top layer 37.

FIG. 4 demonstrates a preferred method according to the present disclosure for producing a layer 57 with net magnetization in a direction that is not perpendicular to the plane of the layer 57. In step 1 shown in FIG. 4(A), the powder particles 30 have a various magnetic moments 38 and so do not produce a significant net magnetization direction. In step 2 shown in FIG. 4(B), a plate 55 is used to apply compressive pressure 60 to the powder layer 57. In step 3 shown in FIG. 4(C), an external magnetic field 39 produced by magnets 20, previously not present, is applied; simultaneously, the compressive pressure 60 continues to be applied via plate 55 and may be increased. In step 4 shown in FIG. 4(D), the external magnetic field 39 is removed. In step 5 shown in FIG. 4(E), the compressive pressure 60 and plate 55 are removed, and the layer 57 is ready for application of a joining process as outlined previously in the present disclosure (including but not limited to: stabilization by binder 40, or partial melting/sintering by a laser or electron beam). The steps of FIG. 4 preferably may be applied repeatedly to produce a part with multiple layers 57 that possess various and potentially unequal net magnetization directions.

A sample item 35 was built with the presence of a weak magnetic field during powder bed binder jet printing and subsequently sintered according to a preferred method of the present disclosure as shown in FIG. 3. FIG. 5 shows the magnetic moment of the sample item 35 as a function of orientation. As outlined in (4) above, the sample item 35 shows a preferred magnetic direction.

FIG. 6 shows an exemplary sintered Ni—Mn—Ga MSMA sample item 65. No composition gradient is present in the sintered structure, and this is needed to ensure property similarity between feedstock powder and final part 65.

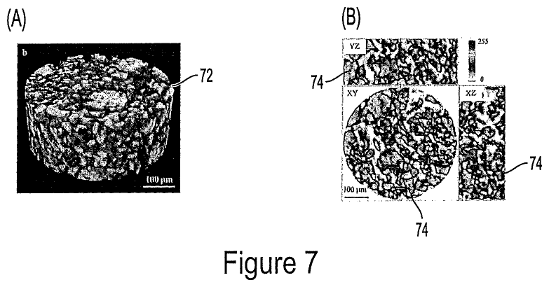

FIGS. 7(A) and 7(B) present micro computed tomography (3D and 2D slices) of a slightly sintered sample showing connected porosity and connected powder particles. FIG. 7(A) shows a micro computed tomography 3D slice 72 of a slightly sintered item made according to a preferred method of the present disclosure. FIG. 7(B) shows micro computed tomography 2D slices 74 of a slightly sintered made according to a preferred method of the present disclosure.

It will be readily understood to those skilled in the art that various other changes in the details, components, material, and arrangements of the parts and methods which have been described and illustrated in order to explain the nature of this disclosure may be made without departing from the principles and scope of the disclosure as expressed in the subjoined claims.

In the foregoing description of preferred embodiments of the present disclosure, various features are grouped together in a single embodiment to streamline the disclosure. This method of disclosure is not to be interpreted as reflecting an intention that the claimed embodiments of the disclosure require more features than are expressly recited in each claim. Rather, as the following claims reflect, inventive subject matter lies in less than all features of a single disclosed embodiment. Thus, the following claims are hereby incorporated into the foregoing description, with each claim standing on its own as a separate embodiment.

What is claimed is:

1. A method for producing an MSMA, a magnetic material or a magnetic item via additive manufacturing, comprising:
(a) providing or forming a layer of magnetic/ferromagnetic particles;
(b) applying a magnetic field, having a first three-dimensional (“3D”) magnetic field vector with respect to an origin point of a 3D coordinate system, to the layer of particles or portion thereof, either while pressure is or is not applied to hold the particles in place, to align the magnetic moments of the magnetic particles in the layer or portion thereof during or after the providing or forming of the layer or portion thereof;
(c) applying means for binding the layer wherein means for binding may comprise a binder material or complete/partial sintering of the layer;
(d) providing or forming a next layer of magnetic/ferromagnetic particulate material on to the previous layer;
(e) applying a magnetic field, having a next 3D magnetic field vector with respect to the origin point of the 3D coordinate system, to the next layer of particles or portion thereof, either while pressure is or is not applied to hold the particles in place, to align the magnetic moments of the magnetic particles in the next layer or portion thereof during or after the providing or forming of the next layer or portion thereof; and
(f) applying means for binding the next layer wherein means for binding may comprise a binder material or complete/partial sintering of next layer.

2. The method of claim 1 wherein the first 3D magnetic field vector is equal to or not equal to the next 3D magnetic field vector.

3. The method of claim 1 further comprising repeating steps (d)-(f) until an interim shape of the item is complete.

4. The method of claim 3 wherein the first 3D magnetic field vector is equal to or not equal to each of the next 3D magnetic field vectors.

5. The method of claim 3 wherein each of the first and next 3D magnetic field vectors is different from each other.

6. The method of claim 3 wherein the 3D magnetic field vectors applied to alternating layers of the item are equal.

7. The method of claim 1 further comprising curing the binder material where a binder material has been used as the means for binding to create an interim shape of the MSMA, the magnetic material or the magnetic item.

8. The method of claim 7 further comprising sintering the interim shape to remove the binder material to produce a final shape of the MSMA, the magnetic material or the magnetic item having increased density and stability.

9. The method of claim 3 wherein the magnetic moments of the particles in each layer have 3D magnetic field vectors that are (i) substantially the same, (ii) parallel, (iii) antiparallel or (iv) different from layer to layer.

10. The method of claim 3 wherein the magnetic moments of the particles in alternating layers have 3D magnetic field vectors that are (i) substantially the same, (ii) parallel or (iii) antiparallel.

11. The method of claim 3 wherein the 3D magnetic field vectors of the magnetic moments of the particles gradually change over a plurality of layers from a first direction relative to one axis of the 3D coordinate system to a second direction relative to said axis.

12. The method of claim 11 wherein the first direction is perpendicular to the second direction.

13. The method of claim 3 wherein net magnetic moments of (i) each layer have 3D magnetic field vectors that are substantially the same, parallel, antiparallel or different from layer to layer; (ii) alternating layers have 3D magnetic field vectors that are substantially the same, parallel or antiparallel; or (iii) each layer have 3D magnetic field vectors that gradually change over a plurality of layers from a first direction relative to one axis of the 3D coordinate system to a second direction relative to said axis, wherein the first direction is or is not perpendicular to the second direction.

14. A magnetic material or item without polymer matrix, comprising:
a plurality of layers wherein each layer comprises magnetic particles and wherein the magnetic moments of the particles in each layer have 3D magnetic field vectors that (i) are substantially the same, (ii) are parallel, (iii) are antiparallel, (iv) are different from layer to layer or (v) gradually change over a plurality of layers from a first direction relative to one axis of a 3D coordinate system to a second direction relative to said axis, wherein the first direction is or is not perpendicular to the second direction.

15. A magnetic material or item without polymer matrix, comprising:
a plurality of layers wherein each layer comprises magnetic particles and wherein a net magnetic moment of each layer has a 3D magnetic field vector that (i) is substantially the same as, parallel to, antiparallel to or different from, the 3D magnetic field vector of each of the other plurality of layers; or (ii) gradually changes over the plurality of layers from a first direction relative to one axis of a 3D coordinate system to a second direction relative to said axis, wherein the first direction is or is not perpendicular to the second direction.
